(19) United States
(12) Patent Application Publication
(10) Pub. No.: US 2007/0285002 A1
(43) Pub. Date: Dec. 13, 2007

(54) Method of Improving the Charge Injection to Organic Films in Organic Thin Film Devices

(75) Inventors: Chuan-Fan Ding, Vancouver (CA); Ping Wang, Shanghai (CN)

Correspondence Address: BERENATO, WHITE & STAVISH, LLC, 6550 ROCK SPRING DRIVE, SUITE 240, BETHESDA, MD, 20817, US

(73) Assignee: Shanghai Jingfeng Electronics Corporation, Shanghai (CN)

(21) Appl. No.: 10/571,350

(22) PCT Filed: Jul. 11, 2005
(86) PCT No.: PCT/CA05/01069

§ 371 Date: Mar. 5, 2007

(30) Foreign Application Priority Data
Jul. 12, 2004 (CN) 200410052792.3

(51) Int. Cl. H05B 33/00; B05D 5/12

(52) U.S. Cl. 313/504; 427/66

(57) ABSTRACT

There is a method of manufacturing organic thin film devices comprising the steps of dissolving an organic material in a first solvent, thereby providing a first solution; dissolving an inorganic salt in a second solvent, thereby providing a second solution; blending the first solution with the second solution, thereby providing a blended solution; and using the blended solution to prepare organic thin films in the manufacture of the organic thin film devices. Alternatively, the inorganic salt may be added directly to the first solution to provide an inorganic salt-doped solution that is then used to prepare the organic thin films in the manufacture of the organic thin film devices.

### BACKGROUND OF THE INVENTION

1. Field of the Invention

This invention relates in general to the material science fields, and more particularly to organic thin film devices.

2. Description of Related Art

The research and development of organic thin film devices has been attracting a great deal of attention over the past two decades. This attention can be attributed to some favorable characteristics of these devices, for example, their fabrication process is rather simple, and the production tools required are relatively uncomplicated and inexpensive. The manufacturing requirements are not strict, and the devices can be fabricated on flexible substrates. In addition, organic materials used in these devices are inexpensive and the consumption of the materials is far less than with competing technologies. These characteristics result in a far lower manufacturing cost than current Si or Ge semiconductor devices, see Shaw, J. M. and Seidler, P. F., Organic Electronics: Introduction, IBM Journal of Research and Development, January 2001, page 3-9, volume 45, IBM Corporation, USA.

Applications of organic thin film devices include, for example, organic thin film transistors (OTFT), organic thin film storage devices (OTFSD), organic light-emitting diodes (OLED), organic thin film solar cells (OTFSC) and organic thin film lasers (OTFL).

OLEDs have been widely acknowledged to have a potential to replace liquid crystal displays (LCD) as the next generation of flat panel display (FPD) technology, as stated by Barry Young, Status of OLED Manufacturing & Search for New Applications, OLEDs. 2003, Intertech, Portland, Me. The light-emitting mechanism of OLED is rather simple. Special light emitting organic materials, e.g. small organic molecular materials and polymers, such as Alq₃, PPV derivatives and polyfluorene derivatives, are inserted between two electrodes. When a voltage is applied to the electrodes, the organic materials emit light. In principle, a single pixel comprises red, green and blue light emitting organic materials, each having respective electrodes. Adjusting the applied voltage on respective electrodes of the three organic materials will result in a certain color of light from the pixel.

OLEDs based flat panel displays have a number of advantages, including high resolution, extraordinary brightness, thinness, light weight, low power consumption and flexibility. Additionally, the manufacturing process for OLED is rather simple. Transparent indium tin oxide (ITO) coated glass substrate or flexible conducting substrate is used as an electrode. Organic materials can be evaporated (for small organic molecules), spin-coated or ink-jet printed (for polymers) onto the electrode. The other electrode is normally deposited onto the organic films by physical vapor deposition (PVD). The thickness of this basic structure of the OLED is on the order of 1 μm. A typical OLED structure is illustrated in FIG. 1, see Tang, C. W. and Van Slyke, S. A. Applied Physics Letter, Organic Electroluminescent Diodes, September 1987, pages 913-915, volume 51, American Institute of Physics, USA; Adachi, C., Tokito, S., Tsutsui, T. and Saito, S. Japanese Journal of Applied Physics, 1988, pages L269 and L713, volume 27, The Japanese Society of Applied Physics, Japan; Burroughes, J. H., Bradley, D. D. D., Brown, A. R., Marks, R. N., Mackay, K., Friend, R. H., Burns, P. L., and Holmes, A. B. Nature, Light-Emitting Diodes Based on Conjugated Polymers, October 1990, pages 539-541, volume 345, Nature Publishing Group, London.

Industrial experts predict that OLED technology will engage the market competition of flat panel displays soon. Austin based DisplaySearch, a market research and consulting firm for displays, predicts that likely 50% of the world mobile phone market will use OLED technology by 2010 and OLED based computer screens and television sets will appear between 2010 to 2015 as stated by Barry Young, Status of OLED manufacturing & the Search for New Applications, OLEDs 2003, Intertech, Portland, Me. Seiko Epson, a Japanese company, and Samsung, a Korean company, have both recently produced a 40 inch prototype of an OLED display.

The most critical issues that have impeded the industrialization of OLED technology are the efficiency and lifetime of OLED displays. Currently, a typical LCD has a lifetime of 50,000 hours, but OLED, at its best, has a lifetime of around 10,000 hours. Extending the lifetime of OLED displays is a core issue among industrial and scientific communities to make OLED technology competitive to make OLED technology competitive, as stated by Barry Young, Status of OLED manufacturing & the Search for New Applications. OLEDs 2003, Intertech, Portland, Me.

A number of methods have been proposed to improve OLED efficiency and extend its lifetime by smoothing interfacial charge injections, e.g. inserting a conducting polymer film between the anode and the organic film, such as PEDOT-PSS, see Groenendael, L., Jonas, F., Fritag, D., Pielartzik, H. and Reynolds, J. R., Advanced Materials, Poly(3,4-ethylenedioxythiophene) and Its Derivatives: Past, Present, and Future, July 2000. pages 481-494, volume 12, Wiley-VCH Verlag GmbH, Germany; inserting a thin layer of inorganic film, such as lithium fluoride, between the cathode and the organic film, see Hung, L. S., Tang, C. W. and Mason, G. C. Applied Physics Letter, Enhanced Electron Injection in Organic Electroluminescence Devices Using an Al/LiF Electrode, January 1997, pages 152-154, volume 70, American Institute of Physics, USA; and most recently inserting a thin layer of organic salt between the anode and the organic film, see Zhao, J. M., Zhan, Y. Q., Zhang, S. T., Wang, X., Zhou, Y. C., Wu, Y., Wang, Z. J., Ding, X. M. and Hou, X. Y. Applied Physics Letter, Mechanisms of Injection Enhancement in Organic Light-Emitting Diodes Through Insulating Buffer, June 2004, pages 5377-5379, volume 84, American Institute of Physics, USA. All of these have certain limitations and the manufacturing processes are complicated.

Doping organic thin films with organic salt was proposed by Alan J. Heeger et al. in 1995. The method can improve light emission, but has a number of disadvantages, see Pei, Q. B., Yu, G. Zhang, C., Yang, Y. and Heeger, A. L. Science, Polymer Light-Emitting Electrochemical Cells, August 1995, pages 1086-1088, volume 269, American Association for the Advancement Science, USA; Pei, Q. B. Yang, Y., Yu, G. Zhang, C. and Heeger, A. J. Journal of American Chemical Society, Polymer Light-Emitting Electrochemical Cells: In Situ Formation of a Light-Emitting p-n Junction, 1996, pages 3922-3929, volume 118, American Chemical Society, USA. It does not raise an attention, and the device doped with organic salt has a severe hysteresis.

### SUMMARY OF THE INVENTION

In a first aspect of the present invention, there is a method of manufacturing organic thin film devices comprising the steps of dissolving an organic material in a first solvent, thereby providing a first solution: dissolving an inorganic salt in a second solvent, thereby providing a second solution; blending the first solution with the second solution, thereby providing a blended solution; and using the blended solution to prepare organic thin films in the manufacture of the organic thin film devices.

In a second aspect of the present invention, there is a method of manufacturing organic thin film devices comprising the steps of dissolving an organic material in a solvent, thereby providing an organic material solution; adding inorganic salt into the organic material solution to form an inorganic salt-doped organic material solution, the inorganic salt-doped organic material solution is used to prepare the organic thin film in the manufacture of the organic thin film devices.

In a third aspect of the present invention, the inorganic salt is from the group consisting of MnXm, where M is a cation. X is an anion and n and m are each whole numbers, wherein the inorganic salt is selected from the group consisting of LiF, LiCl, LiBr, LiI, NaF, NaCl, NaBr, NaI, KF, KCl, KBr, KI, RbF, RbCl, RbBr, RbI, CsF, CsCl, CsBr, CsI, BeF₂, BeCl₂, BeBr₂, BeI₂, MgF₂, MgCl₂, MgBr₂, MgI₂, CaF₂, CaCl₂, CaBr₂, CaI₂, SrF₂, SrCl₂, SrBr₂, SrI₂, BaF₂, BaCl₂, BaBr₂ and Bal₂. Other types of inorganic salts also may be used. In other aspects of the invention, other metal ions, such as transition metals, can also be used as a dopant in the organic material.

In a fourth aspect of the present invention, there is an organic thin film device. The organic thin film device includes at least a pair of electrodes and a thin film of inorganic salt-doped organic material adjacent each of the electrodes. In further aspects of the present invention, there may be three or more electrodes used in the thin film device.

### BRIEF DESCRIPTION OF THE DRAWINGS

The present invention will be more readily understood from the following description of preferred embodiments thereof given, by way of example, with reference to the accompanying drawings, in which:

FIG. 1 is a schematic view of a prior art organic light emitting diode;

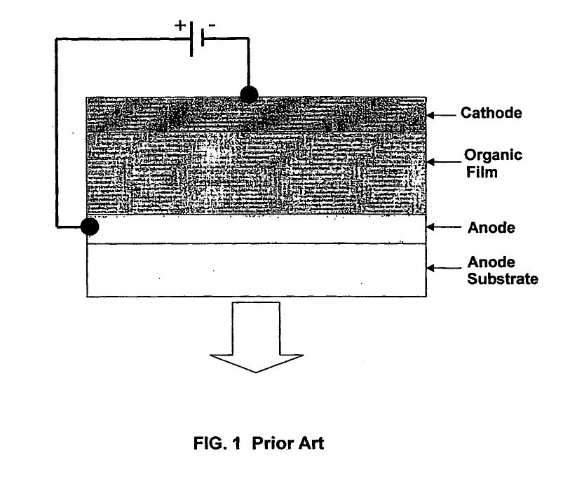

FIG. 2 is a schematic view of an organic light emitting diode of one embodiment of the present invention; and

FIG. 3 is a schematic view of the organic light emitting diode of FIG. 2 under a voltage bias.

### DETAILED DESCRIPTION OF THE PREFERRED EMBODIMENTS

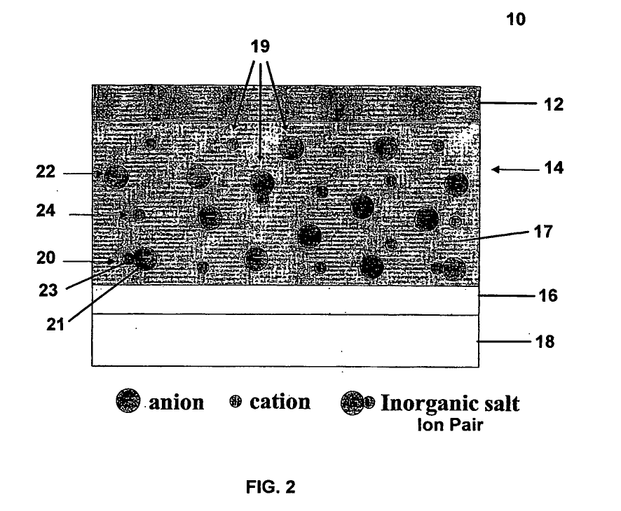

Referring to the figures and first to FIG. 2, this shows an organic light emitting diode (OLED) indicated generally by reference numeral 10. The OLED 10 comprises a cathode 12, an inorganic salt-doped organic thin film indicated generally by reference numeral 14, an anode 16 and an anode substrate 18. The organic thin film 14 comprises an organic material 17 doped with one or more inorganic salts indicated generally by reference numeral 19.

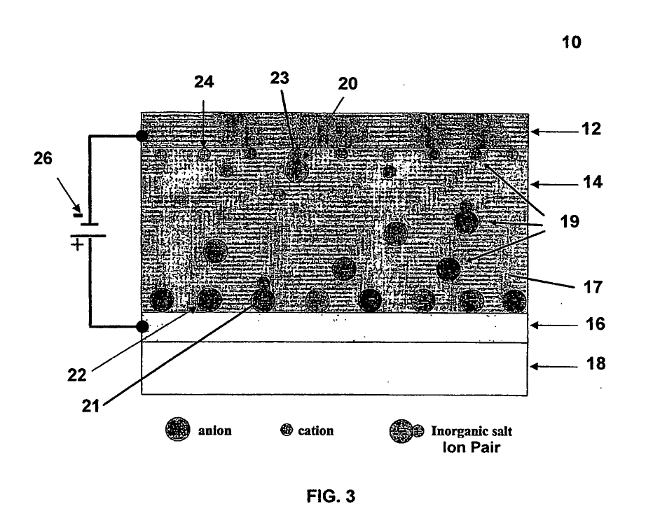

The inorganic salts 19 exist in the film 14 as an ionic species having anions 22 and cations 24, or ion pairs indicated generally by reference numeral 20, or both. The ion pairs 20 have a negative pole 21 and a positive pole 23. Under an external voltage 26, as shown in FIG. 3, the cations 24 move toward the cathode 12 and the anions 22 move toward the anode 16, and the ion pairs 20 reorient with the negative poles 21 pointed to the anode 16 and the positive poles 23 pointed to the cathode 12, which results in a strong interfacial polarization.

Generally speaking, the anions 22 attracted to the anode 16, under the bias of the external voltage 26, increase the anode work-function, and therefore lower the charge injection barrier between anode Fermi level and the highest occupied molecular orbital (HOMO), which improves the hole injection from anode 16 to the organic material 17. With the ion pair 20 reorientated as described above, the negative pole 21 points to the anode 16, which also increases the anode work function, and therefore also lowers the hole injection barrier.

At the cathode 12, the cations 24 attracted to the cathode 12, due to the bias of the external voltage 26, decrease the cathode work-function, and therefore lower the charge injection barrier between cathode Fermi level and the lowest unoccupied molecular orbital (LUMO), which improves the electron injection from the cathode 12 to the organic material 17. With the ion pair 20 reorientated as described above, the positive pole 23 points to the cathode 12, which also decreases the cathode work-function, and therefore also lowers the electron injection barrier.

In this example, the organic material 17 comprises polymer materials, which usually have long alkyl chains in order to improve the solubility, which, therefore, prevents the film 14 from being tightly assembled. Since the sizes of the anions 22 and the cations 24 and the inorganic salt 19 are small, the ionic species can easily move in the film 14 and the ion pairs 20 have no problem to reorientate in the film in an expedient manner, which results in a fast response to the external voltage 26.

Theoretically, a single layer of ions on the cathode 12 and the anode 16 can enhance the interfacial charge injection, and therefore the doping level can be low. Consequently, the doping of the organic material 17 with the inorganic salts 19 may have no obvious effect on film morphology and emission spectrum. The method also has no need to make a big change in current OLED manufacturing processes.

The general formula of the inorganic salt 19 is MnXm, where M is the cation 24, X is the anion 22, and n and m are each whole numbers, e.g. 1, 2, 3, 4, 5, 6 and 7. The cation 24 includes metal cations, and the anion 22 can include halogen and complex anions. The complex anions can include carbonate, perchlorate and fluoroboric anions. It is understood that one or more different inorganic salts can be used concurrently as dopants for the organic material 17, and in some examples there may be more than one organic material present.

The inorganic salt 19 may be selected, for example, from the following list of inorganic salts: LiF, LiCl, LiBr, LiI, NaF, NaCl, NaBr, NaI, KF, KCl, KBr, KI, RbF. RbCl, RbBr, RbI, CsF, CsCl, CsBr, CsI, BeF₂, BeCl₂, BeBr₂, BeI₂, MgF₂, MgCl₂, MgBr₂, MgI₂, CaF₂, CaCl₂, CaBr₂, CaI₂, SrF₂, SrCl₂, SrBr₂, SrI₂, BaF₂, BaCl₂, BaBr₂ and BaI₂. Other types of inorganic salts also may be used.

The OLED 10 of this embodiment is fabricated according to the following methods. The organic material 17 can be doped with the inorganic salt 19 by a solution process or by other processes; however, the solution process is the simplest. The typical steps in the solution process are discussed below. It is understood that the whole process should be operated in a controlled environment, e.g. a glove box.

An inorganic salt solution is prepared by dissolving an inorganic salt in a solvent. The inorganic salt may be a pure inorganic salt or a mixture of inorganic salts. The solvent may be a pure solvent or a mixture of solvents, for example, one of or a mixture of tetrahydrofuran, chloroform, 1,4-dioxane, acetonitrile, water, ethyl acetate, acetone, pyridine, ethylene glycol and methanol. After the inorganic salt dissolves, the inorganic salt solution can be filtered when needed. For example, the inorganic salt solution can be filtered by diluting the solution with a solvent.

An organic material solution is prepared by dissolving a light-emitting organic material into a solvent. The solvent may be a pure solvent or a mixture of solvents. As an example, polyfluorene can be dissolved in toluene, o-xylene or p-xylene, and MEH-PPV can be dissolved in chloroform, tetrahydrofuran (THF) or chlorobenzene. The concentration of the organic material in the solution is determined by the thickness requirement of the film. The organic material solution is next filtered.

The inorganic salt solution is blended with the organic material solution to make the doped organic materials solution. Generally, the doping level of the inorganic salt is very low, which does not affect the film thickness and morphology. The concentration of inorganic salt in the doped solution is around 0.1 ppb to 10,000 ppm. The exact concentration is determined by the requirements of the light emitting material.

The blended solution is used to spin-cast or ink-jet print a film of the inorganic salt-doped organic material onto an electrode substrate. The other electrode is deposited on the film, thereby producing a single layer device. The above method can be extended to fabricate multilayer structures.

Inorganic salt can also be directly added into the organic material solution to prepare the inorganic salt-doped organic material solution, which is used to fabricate the film by either spin-casting or ink-jet printing.

Doping organic light emitting materials with one or more inorganic salts not only improves the light emission efficiency, but also lowers the turn-on voltage, which makes the usage of lower work function metals for electrodes unnecessary, and simplifies the manufacturing process.

The above method to improve the charge injection of organic thin film devices is a general approach, and can be applied to any light-emitting materials to improve the light emission efficiency and lifetime.

A further advantage of the above method to improve the charge injection of organic thin film devices is an improvement in the efficiency and in the lifetime of the various colored OLEDs, e.g. red, green, blue and white.

Although the above description uses OLEDs as an illustrative example, the method of inorganic salt doping can be widely applied to all organic thin film devices to improve interfacial charge injections to further enhance their operations.

As will be apparent to those skilled in the art, various modifications to the above described embodiments may be made within the scope of the appended claims.

What is claimed is:

1. A method of manufacturing organic thin film devices comprising the steps of:
dissolving organic material in a first solvent, thereby providing a first solution;
dissolving inorganic salt in a second solvent, thereby providing a second solution;
blending the first solution with the second solution, thereby providing a blended solution; and
using the blended solution to prepare inorganic salt-doped organic material thin films in the manufacture of the organic thin film devices.

2. The method of manufacturing organic thin film devices as claimed in claim 1, wherein the step of dissolving organic material further includes the step of filtering the first solution.

3. The method of manufacturing organic thin film devices as claimed in claim 1, wherein the step of dissolving inorganic salt further includes the step of filtering the second solution.

4. The method of manufacturing organic thin film devices as claimed in claim 1, wherein the step of using the blended solution to prepare organic thin films comprises the step of spin-casting the blended solution onto a substrate.

5. The method of manufacturing organic thin film devices as claimed in claim 1, wherein the step of using the blended solution to prepare organic thin films comprises the step of spraying the blended solution through a nozzle onto a substrate like in ink-jet printing.

6. The method of manufacturing organic thin film devices as claimed in claim 3, wherein the step of filtering the second solution further includes the step of diluting the inorganic salt second solution with one of the first solvent or the second solvent.

7. The method of manufacturing organic thin film devices as claimed in claim 1, wherein the blended solution has a concentration of inorganic salt between 0.1 ppb to 10,000 ppm.

8. The method of manufacturing organic thin film devices as claimed in claim 1, wherein the inorganic salt is from the group consisting of MnXm, where M is a cation, X is an anion and n and m are each whole numbers.

9. The method of manufacturing organic thin film devices as claimed in claim 8, wherein the inorganic salt is selected from the group consisting of LiF, LiCl, LiBr, LiI, NaF, NaCl, NaBr, NaI, KF, KCl, KBr, KI, RbF, RbCl, RbBr, RbI, CsF, CsCl, CsBr, CsI, BeF₂, BeCl₂, BeBr₂, BeI₂, MgF₂, MgCl₂, MgBr₂, MgI₂, CaF₂, CaCl₂, CaBr₂, CaI₂, SrF₂, SrCl₂, SrBr₂, SrI₂, BaF₂, BaCl₂, BaBr₂ and BaI₂.

10. A method of manufacturing organic thin film devices comprising the steps of:
dissolving organic material in a solvent, thereby providing a solution;
adding inorganic salt into the solution to make an inorganic salt-doped organic material solution; and
using the inorganic salt-doped organic material solution to prepare organic thin films in the manufacture of organic thin film devices.

11. The method of manufacturing organic thin film devices as claimed in claim 10 wherein the step of dissolving organic material further includes the step of filtering the solution.

12. The method of manufacturing organic thin film devices as claimed in claim 10, wherein the method further includes the step of filtering the inorganic salt-doped organic material solution.

13. The method of manufacturing organic thin film devices as claimed in claim 10, wherein the step of using the inorganic salt-doped organic material solution to prepare organic thin films comprises the step of spin-casting the inorganic salt-doped organic material solution onto a substrate.

14. The method of manufacturing organic thin film devices as claimed in claim 10, wherein the step of using the inorganic salt-doped organic material solution to prepare organic thin films comprises the step of spraying the inorganic salt-doped organic material solution through a nozzle onto a substrate like in ink-jet printing.

15. The method of manufacturing organic thin film devices as claimed in claim 10, wherein the inorganic salt-doped organic material solution has a concentration of inorganic salt between 0.1 ppb to 10,000 ppm.

16. The method of manufacturing organic thin film devices as claimed in claim 10, wherein the inorganic salt is from the group consisting of MnXm, where M is a cation, X is an anion and n and m are each whole numbers.

17. The method of manufacturing organic thin film devices as claimed in claim 10, wherein the inorganic salt is selected from the group consisting of LiF, LiCl, LiBr, LiI, NaF, NaCl, NaBr, NaI, KF, KCl, KBr, KI, RbF, RbCl, RbBr, RbI, CsF, CsCl, CsBr, CsI, BeF₂, BeCl₂, BeBr₂, BeI₂, MgF₂, MgCl₂, MgBr₂, MgI₂, CaF₂, CaCl₂, CaBr₂, CaI₂, SrF₂, SrCl₂, SrBr₂, SrI₂, BaF₂, BaCl₂, BaBr₂ and BaI₂.

18. The method of manufacturing organic thin film devices as claimed in claim 1, wherein the first solvent is a pure solvent.

19. The method of manufacturing organic thin film devices as claimed in claim 1, wherein the first solvent is a mixture of pure solvents.

20. The method of manufacturing organic thin film devices as claimed in claim 1, wherein the second solvent is a pure solvent.

21. The method of manufacturing organic thin film devices as claimed in claim 1, wherein the second solvent is a mixture of pure solvents.

22. The method of manufacturing organic thin film devices as claimed in claim 1, wherein the inorganic salt is a pure inorganic salt.

23. The method of manufacturing organic thin film devices as claimed in claim 1, wherein the inorganic salt is a mixture of pure inorganic salts.

24. The method of manufacturing organic thin film devices as claimed in claim 10, wherein the solvent is a pure solvent.

25. The method of manufacturing organic thin film devices as claimed in claim 10, wherein the solvent is a mixture of pure solvents.

26. The method of manufacturing organic thin film devices as claimed in claim 10, wherein the inorganic salt is a pure inorganic salt.

27. The method of manufacturing organic thin film devices as claimed in claim 10, wherein the inorganic salt is a mixture of pure inorganic salts.

28. An organic thin film device comprising:
at least a pair of electrodes; and
a thin film of inorganic salt-doped organic material being adjacent each of the electrodes.

29. An organic thin film device comprising:
at least a pair of electrodes; and
a thin film of inorganic salt-doped organic material as manufactured in claim 1 being adjacent each of the electrodes.

30. An organic thin film device comprising:
at least a pair of electrodes; and
a thin film of inorganic salt-doped organic material as manufactured in claim 10 being adjacent each of the electrodes.

31. The organic thin film device as claimed in claim 28, wherein the thin film device further comprises a third electrode, the thin film of inorganic salt-doped organic material being adjacent the third electrode.
